(19) United States
(12) Patent Application Publication
(10) Pub. No.: US 2026/0105758 A1
(43) Pub. Date: Apr. 16, 2026

(54) LEVERAGING LLMS FOR VIDEO ANALYSIS

(71) Applicant: NEC Laboratories America, Inc., Princeton, NJ (US)

(72) Inventors: Abhishek Aich, San Jose, CA (US); Yumin Suh, Santa Clara, CA (US); Manmohan Chandraker, Santa Clara, CA (US)

(21) Appl. No.: 19/355,027

(22) Filed: Oct. 10, 2025

Related U.S. Application Data
(60) Provisional application No. 63/706,215, filed on Oct. 11, 2024.
(60) Provisional application No. 63/767,030, filed on Mar. 5, 2025.

(51) Int. Cl. G06V 20/58; G05D 1/243; G06V 20/40

(52) U.S. Cl. CPC G06V 20/58; G05D 1/2435; G06V 20/41

(57) ABSTRACT

Methods and systems for video processing include performing analyses on an input video from a vehicle to generate respective outputs. The outputs are combined into a structured hierarchical format that divides outputs into frame-level and video-level information. The outputs in the structured hierarchical format are processed using a large language model (LLM) to determine a driving action. The driving action is performed in the vehicle.

### RELATED APPLICATION INFORMATION

This application claims priority to U.S. Patent Application No. 63/706,215, filed on Oct. 11, 2024, and to U.S. Patent Application No. 63/767,030, filed on Mar. 5, 2025, each incorporated herein by reference in its entirety.

### BACKGROUND

### Technical Field

The present invention relates to image analysis and, more particularly, to using vision language models and large language models to perform object analysis.

### Description of the Related Art

Continuous and offline analysis of large amounts of video data, such as are collected by advanced driver assistance systems, help to assess a system's responses to different scenarios, identify potential causes of failures, and refine algorithms to improve decision-making processes. However, analyzing large amounts of video data incurs large time and labor costs. Furthermore, training automated pipelines needs annotations across multiple granular tasks.

### SUMMARY

A method for video processing includes performing analyses on an input video from a vehicle to generate respective outputs. The outputs are combined into a structured hierarchical format that divides outputs into frame-level and video-level information. The outputs in the structured hierarchical format are processed using a large language model (LLM) to determine a driving action. The driving action is performed in the vehicle.

A video processing system includes a hardware processor and a memory that stores a computer program. When executed by the hardware processor, the computer program causes the hardware processor to perform analyses on an input video from a vehicle to generate respective outputs, to combine the outputs into a structured hierarchical format that divides outputs into frame-level and video-level information, to process the outputs in the structured hierarchical format using an LLM to determine a driving action, and to perform the driving action in the vehicle.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram of a video analysis system that combines the outputs of task-specific video analysis tasks into a structured hierarchical format suitable for use by a large language model (LLM), in accordance with an embodiment of the present invention;

FIG. 2 is an example of video analysis outputs stored in a structured hierarchical format, in accordance with an embodiment of the present invention;

FIG. 3 is a block/flow diagram of a method of analyzing video from a dash-cam in a vehicle for use in performing self-driving actions, in accordance with an embodiment of the present invention;

FIG. 4 is a diagram of an exemplary road scene, captured by a dash cam in a vehicle, in accordance with an embodiment of the present invention;

FIG. 5 is a diagram of a self-driving vehicle that can perform driving actions responsive to video analysis based on information gathered by a camera, in accordance with an embodiment of the present invention;

FIG. 6 is a diagram showing an exemplary neural network architecture that can be used to implement part of an LLM, in accordance with an embodiment of the present invention; and

FIG. 7 is a diagram showing an exemplary deep neural network architecture that can be used to implement part of an LLM, in accordance with an embodiment of the present invention.

### DETAILED DESCRIPTION OF PREFERRED EMBODIMENTS

A modular video analysis system can be built using human inductive bias, which combines multiple vision modules and a large language model (LLM) that generates responses to user queries. Diverse vision outputs are translated into a consistent data structure, making it possible to use natural language queries, explanation, and other reasoning about complex video scenes.

Post-video analysis may be decomposed into vision-based modules that are trained for specific vision tasks, such as open-vocabulary trackers, lane detection, and distance estimation, and LLMs that perform reasoning on the video content generated by the vision-based modules. The outputs of the vision modules are bridged using heuristics to translate them into a form that the LLM can process and analyze. Key details are captured in a structured manner, and the complete knowledge of the pre-trained LLM is leveraged to provide a comprehensive report.

In this manner, any ego-view front camera video can be analyzed in an end-to-end, zero-shot manner. The video may be analyzed using pretrained models without fine-tuning. The video information is translated to a shared format, including a video-level information field and a frame-level information field. The video-level information field includes information such as weather, road condition, and daytime condition. A source vehicle's motion and turn states can be added at various frames. The frame-level information field includes fine-grained details of each object per frame, providing a list of entries corresponding to a number of frames in the video. This shared-format information is analyzed by the LLM.

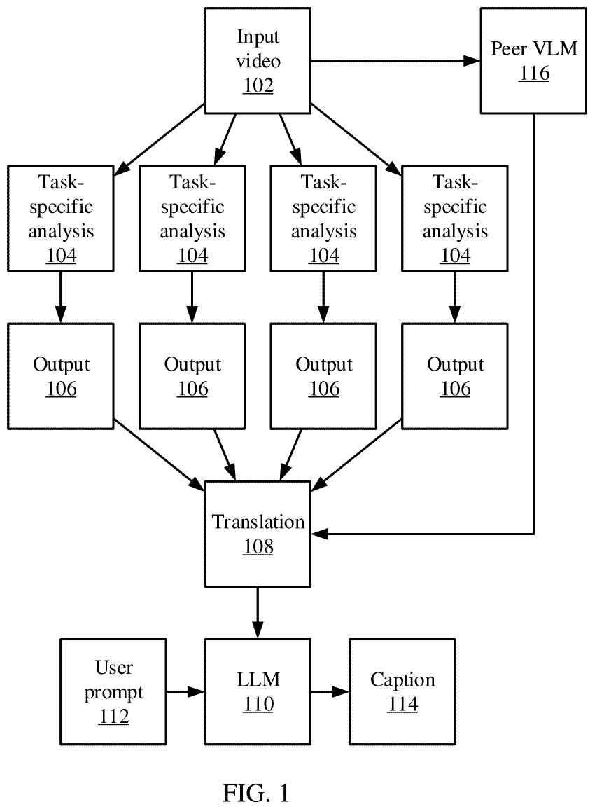

Referring now to FIG. 1, a diagram of video analysis is shown. An input video 102 is received from, e.g., an advanced driver assistance system (ADAS) in a self-driving vehicle. A set of different-task specific analysis 104 are performed on the input video. Exemplary video analyses include lane detection, object detection, distance estimation, and orientation estimation. The task-specific analyses 104 may be performed using computer vision models that extract key information from the input video frames. Although such ADAS embodiments are specifically contemplated, it should be understood that the input video 102 may be drawn from any appropriate source and that any appropriate video analysis may be performed.

Each of the task-specific analyses 104 produces a respective output 106. Translation 108 combines the outputs 106 into a unified output that is suitable for use by an LLM 110. The LLM 110 receives a user prompt 112 and performs a corresponding analysis on the unified output to generate a caption 114 for the input video 102. The LLM 110 may further receive information from a peer visual language model (VLM) 116 that processes the video 102 directly to generate a first-pass interpretation. This hypothesis may be refined by the LLM using structured evidence from the task-specific analyses 104.

These analyses 104 may be performed in a post-analysis setting, for example by recording the input video 102 during operation of a vehicle and performing the analysis after the vehicle has stopped operating. In a post-analysis setting, the accuracy of the analysis is more important than the speed or other performance metrics. As adequate training data may not be available for rare circumstances, computer vision models may be used to fill in vision-guided details, while the LLM 110 adds reasoning capabilities.

The input video 102 may include distortions that come from the camera itself. These distortions may be corrected through the estimation of camera parameters and the rectification of the frames. A multi-task function [symbol] processes the corrected input video 102 and extracts the structured outputs 106 that provide a comprehensive understanding of the driving scene. The input video 102 may be represented as a sequence of T frames v=(I₁, I₂, . . . , I_{T}), where each frame Iₜ ∈ [symbol] ^{H×W×3} is the t^{th} image of height H and width W.

Types of analysis that can be performed include scene understanding, object detection, lane detection, and depth estimation. A vision language model may extract high-level information, such as weather conditions, road structure, and different objects in the scene. This provides a holistic interpretation of the environment and can support diverse reasoning tasks. Two-dimensional and three-dimensional object detection locate objects, such as vehicles and pedestrians and can furthermore estimate real-world spatial coordinates, dimensions, and orientation of detected objects.

The structured output for each frame Iₜ includes multiple components, for example including two-dimensional bounding boxes and object classes, three-dimensional bounding boxes, lane markings, and object distances. The two-dimensional bounding boxes may locate detected objects as:

$${B}_{t} = {\{ ( {b}_{t , i} , {c}_{t , i} ) \}}_{i = 1}^{{n}_{t}}$$

where b_{t,i} ⊂ [symbol] ⁴ is a two-dimensional bounding box parameterized by (xₘᵢₙ, yₘᵢₙ, xₘₐₓ>yₘₐₓ), and c_{t,i} denotes an object class for the i^{th} detected object in frame t. The bounding box is obtained using a two-dimensional object detection model.

For objects with depth information, a three-dimensional bounding box may be defined as:

$${P}_{t} = {\{ ( {p}_{t , i} , {c}_{t , i} ) \}}_{i = 1}^{{n}_{t}}$$

where p_{t,i} ⊂ [symbol] ⁷ describes the three dimensional position and orientation of the bounding box in the scene, parameterized as (X, Y, Z, l, w, h, θ) in a chosen coordinate frame (e.g., camera-centered or world-centered).

Lane detection outputs a representation Lₜ ⊂P{0,1}^{H×W} which can take the form of a segmentation mask, polynomial coefficients, or spline parameters describing lane curves on the image plane. Per-object distance from the camera is represented as

$${D}_{t} = {\{ {d}_{t , i} \}}_{i = 1}^{{n}_{t}} ,$$

where d_{t,i} ∈ [symbol] ⁺ denotes the distance from the camera to the i^{th} detected object. The structured output for each frame t may thus be written as Yₜ=(Bₜ, Pₜ, Lₜ, Dₜ). The overarching function [symbol] may be applied to the entire video:

$$ℱ : {ℝ}^{T \times H \times W \times 3} \to {\prod }_{t = 1}^{T} ( ℬ \times 𝒫 \times ℒ \times 𝒟 )$$

such that [symbol] (v)=(Y₁, Y₂, . . . , Y_{T}). A single function [symbol] takes the input video 102 and outputs a suite of perception results. Formally,

$$ℱ ( v ) = {\{ ( {B}_{t} , {P}_{t} , {L}_{t} , {D}_{t} ) \}}_{t = 1}^{T} .$$

In practice, [symbol] may be decomposed into multiple specialized modules, including feature extraction, two-dimensional object detection, three-dimensional object detection, lane segmentation, and depth estimation. Each module can be independently trained or fine-tuned in a joint learning framework to enhance accuracy and robustness across diverse environments.

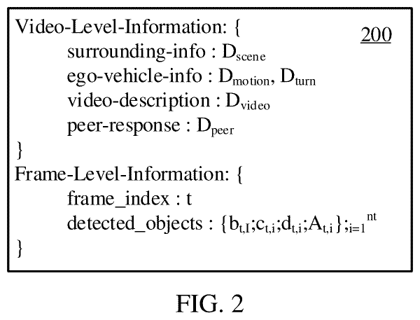

Referring now to FIG. 2, an example of a shared format 200 is shown for the outputs 106 of the different task-specific analyses 104. This format shows video-level information and frame-level information being combined into a structured format where the outputs 106 of different task-specific analyses 104 are included on separate lines. Translation 108 converts these respective outputs 106 into the shared format 200 so that the LLM 110 has context for what each of the values represents.

Types of video-level information may include natural language descriptions of the surrounding scene, information about the vehicle such as its direction and speed, a natural language description of what is happening in the video, and the behavior of other vehicles in the scene. Types of frame-level information may include object detection information for a particular frame, such as a bounding box for a detected object, its attributes, its distance, and an identification of its relationship to the ego vehicle.

The user prompt 112 may ask the LLM 110 questions about the scene, based on this combined output in structured format 200. For example, the user prompt 112 may include a query such as, “Is there a car coming in the opposite direction?” To which the LLM 110 may generate a caption 114 for the video, “Yes, there is a white sedan on the lane left of the ego lane.”

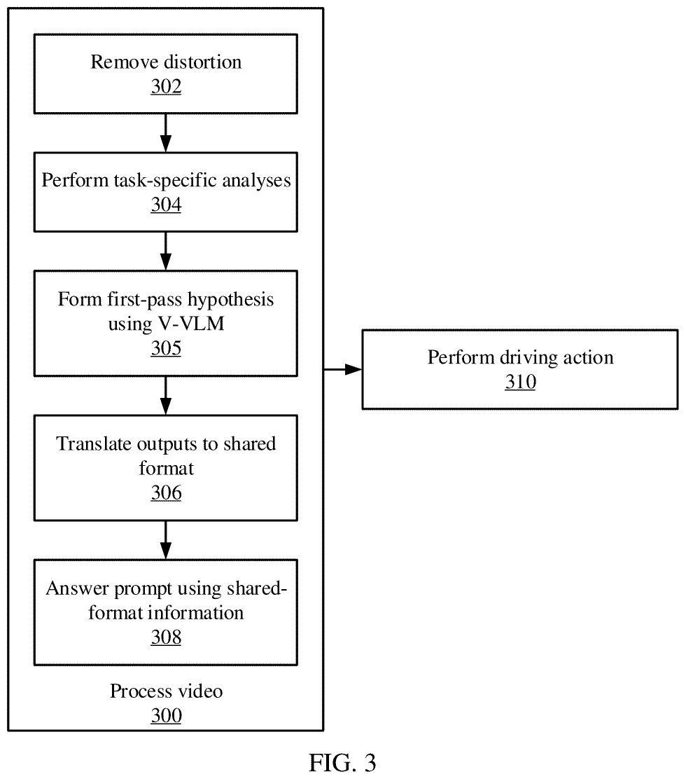

Referring now to FIG. 3, a method for answering queries about a video is shown. Block 300 processes incoming video from, e.g., the dash-cam of a vehicle. Block 302 removes distortions from frames of the input video 102. Front-view dash-cam videos often include distortions that result from the characteristics of front-facing cameras. Block 302 corrects these distortions through estimation of camera intrinsics, such as focal length and principal point, and distortion coefficients, such as radial distortion [k₁, k₂, k₃] and tangential distortion [p₁, p₂] coefficients. To correct for lens distortion, a mapping function [symbol] transforms coordinates in the rectified (undistorted) image I to corresponding coordinates in the distorted image Ia. The rectified image is obtained as:

$$I ( x , y ) = {I}_{d} ( {ℛ}^{- 1} ( x , y ) )$$

where [symbol] ⁻¹ (x, y) computes corresponding distorted coordinates for each undistorted pixel location (x, y) using the estimated camera intrinsic matrix and distortion coefficients.

Block 304 then performs the task-specific analyses on the rectified frames of the input video 102. These analyses may include, e.g., scene understanding, vehicle state estimation, two-dimensional object detection and tracking, object lane location, object distance estimation, object attribute identification, and three-dimensional detection for object orientation. Because these task-specific analyses 104 are executed on the input video 102 independently, they may be performed in parallel to speed execution.

Scene understanding captures general environment details, such as weather conditions, road structure, and whether it is day or night. A caption may be generated to describe the events shown in the video. High-level scene understanding helps the LLM 110 to reason about vehicle movements, pedestrian actions, and traffic interactions. To extract surrounding environment information D_{scene}, an image-based vision-language model (VLM) [symbol] provides a precise and reliable interpretation of the video. Image-based VLMs lack the ability to capture the evolution of events over time. To capture temporal dynamics, a video-based V-VLM [symbol] generates a detailed description D_{video} of the video:

$${ℱ}_{1 - VLM} : ( V , {P}_{1} ) \to {D}_{scene}$$

$${ℱ}_{V - VLM} : ( V , {P}_{V} ) \to {D}_{video}$$

where P_{I} and P_{V} are prompts to the respective VLMs.

Vehicle state estimation captures the vehicle's motion and turn actions. Understanding these actions helps to reason in front-view dash-cam videos where the vehicle's perspective defines the driving scene. Estimating camera pose for front-view videos provides the vehicle's motion pattern in the input video. However, these numerical pose outputs are not inherently interpretable by an LLM. To bridge this gap, the raw pose data is transformed into human-interpretable driving states by estimating the vehicle's turning behavior and motion status.

A camera-pose estimation model [symbol] maps video frames V to a sequence of translation vectors

$${\{ {T}_{t} \}}_{t = 1}^{T} ,$$

where Tₜ=(Xₜ, Yₜ, Zₜ) ∈ [symbol] ³ denotes the camera position at time t. The heading angle of the camera Δθᵢ is estimated across T time steps using (Xₜ, Zₜ) ∀t ∈ {1, . . . , T} as:

$$Δ {θ}_{t} = {tan}^{- 1} ( {Z}_{t + 1} - {Z}_{t} / {X}_{t + 1} - {X}_{t} ) - {tan}^{- 1} ( {Z}_{t} - {Z}_{t - 1} / {X}_{t} - {X}_{t - 1} )$$

Next, Δθₜ is used to classify the vehicle's turn into the three categories (with Ta as threshold) as

$${D}_{turn} = “ Straight ” if \vert {Δθ}_{t} \vert < {τ}_{a} , “ Right Turn ” if {Δθ}_{t} > {τ}_{a} , else “ Left Turn ”$$

The vehicle's motion is estimated over a temporal window g using

$${s}_{t} = ‖ {T}_{t + g} - {T}_{t} ‖ / g , ∀ t ∈ \{ 1 , ⋯ , T - g \} ,$$

where sₜ denotes the approximate speed at time t, used to classify the vehicle's motion state as

$${D}_{motion} = “ Stopped ” if {s}_{t} < {τ}_{s} , else “ Moving ”$$

where τₛ represents the speed threshold for detecting a stopped vehicle. By incorporating both turning and motion status, the vehicle state is structured as

$${ℱ}_{ego} : {\{ ( {I}_{t} , {T}_{t} ) \}}_{t = 1}^{T} \to ( {D}_{motion} , {D}_{turn} )$$

While video-level cues provide global understanding, many significant driving events, such as pedestrian crossings, vehicle interactions, and traffic signal changes, occur at the frame level. To fully comprehend the driving scenario, frame-level information is extracted to ensure that the model can reason about both long-term motion trends and momentary scene dynamics.

For example, the objects in the video may be captured and tracked. To accurately analyze dynamic interactions of objects with the vehicle in a driving scene, objects are not only detected in individual frames but also tracked over time using a unique identity. Furthermore, this provides the foundation for identifying attributes of the objects, such as their lane location, distance, and attributes.

For each video frame Iₜ, a 2D object detection model [symbol] D-det is applied as

$${ℱ}_{2 D - det} : ( {I}_{t} ) \to {\{ ( {b}_{t , i} , {c}_{t , i} ) \}}_{i = 1}^{{n}_{t}} .$$

Here b_{t,i}=(xₘᵢₙ, yₘᵢₙ, xₘₐₓ, yₘₐₓ) ∈ [symbol] ⁴ is the bounding box and c_{t,i} is the class label for i^{th} object. The value nₜ is the number of objects detected in frame t. A tracker on the detections assigns unique ID γ_{t,i} to each detected object Bₜ=(b_{t,i}, c_{t,i}) using a multi-object tracking model [symbol] as [symbol] : (Bₜ, Kₜ₋₁)→Kₜ. For each video frame Iₜ, this step provides

$${ℱ}_{2 D - det - track} : ( {I}_{t} ) \to {\{ {γ}_{t , i} , {b}_{t , i} , {c}_{t , i} \}}_{i = 1}^{{n}_{t}}$$

Object lane detection assigns the lane location of the object in the scene. The vehicle's driving decisions are influenced by the lane positions of surrounding objects. Therefore the data structure [symbol] encodes lane information for each detected object, particularly for vehicles and pedestrians. As in state estimation, the numerical outputs of lane detection models are not inherently interpretable by an LLM. To bridge this gap, the raw lane marking data is translated into human-interpretable states by estimating the vehicle's lane location.

Lane assignment is performed using the detected objects in the scene. Lane detection model [symbol] first obtains the predicted lane markings in each frame Iₜ as

$${ℱ}_{lane} ( {I}_{t} ) : ( {I}_{t} ) \to {\{ {I}_{t , j} \}}_{j = 1}^{mt} .$$

Here, l_{t,j} represents the set of j^{th} lane marking coordinates, and mₜ is the total number of detected lane markings. Next, the road is divided into mₜ+1 lane sections formed by the lane markings. Each lane section is now defined as

$${s}_{t , k} = \{ ( x , y ) \vert {x}_{{l}_{t , j}} \leq x \leq {x}_{{l}_{t , j + 1}} , y = [ {y}_{max , {L}_{t}} , H ] \}$$

where xₗ_{_{t,k}} is the x-coordinate of the k-th lane marking,

$${y}_{max , {L}_{t}} = {min}_{j} {y}_{{l}_{t , j}}$$

is the highest point of all lane markings (assuming image coordinates have the origin at the top-left). For each i th object in frame t, the midpoint p_{t,i} of its bounding box bottom edge as p_{t,i}=(xₘᵢₙ+xₘₐₓ/2, yₘₐₓ) is estimated. Then, its lane λ_{t,i} is estimated as

$${λ}_{t , i} = k such that {p}_{t , i} ∈ {s}_{t , k}$$

The vehicle's lane λ_{t,ego} is estimated using the bottom-center pixel p_{t,ego}=(W/2, H) as a reference. The resulting lane data is then added to [symbol] for each frame:

$${ℱ}_{lane} : ( {I}_{t} , {K}_{t} ) \to ( {\{ {λ}_{t , i} \}}_{i = 1}^{{n}_{t}} , {λ}_{t , ego} ) .$$

Object distances can be estimated with respect to the vehicle. Distance-awareness of each object will allow the LLM to analyze collisions, vehicle navigation, and object interaction. Given an input frame Iₜ, a depth estimation model [symbol] predicts a metric depth map [symbol] : (Iₜ)→Dₜ where, Dₜ ∈ [symbol] ^{H×W} is the estimated depth map for frame t. For i th object's bounding box b_{t,i}=(xₘᵢₙ>yₘᵢₙ, xₘₐₓ>yₘₐₓ), the cropped depth region corresponding to the object is D_{t,i}=Dₜ[xₘᵢₙ:xₘₐₓ, yₘᵢₙ:yₘₐₓ]. Next, to make the region of the object more precise and eliminate any background pixel, a segmentation model [symbol] predicts a binary mask M_{t,i} for the object within b_{t,i}. The final distance d_{t,i} of the object from the vehicle is computed as the mean distance of the masked region. d_{t,i}=mean(D_{t,i}⊙M_{t,i}), where ⊙ denotes the element-wise multiplication. Finally, the distance information per object per frame is added to [symbol] as follows:

$${ℱ}_{dist} : ( {I}_{t} , {K}_{t} ) \to {\{ {d}_{t , i} \}}_{i = 1}^{{n}_{t}}$$

Object attributes, such as color, can be used by the LLM to distinguish the objects in a human-interpretable manner. Object attributes enhance perception with human-like reasoning and are useful for scene interpretation and high-level decision-making. With b_{t,i}=(xₘᵢₙ, yₘᵢₙ, xₘₐₓ, yₘₐₓ), the VLM [symbol] extracts object attributes such as the color of vehicles and traffic light color using a prompt P_{d}:

$${ℱ}_{( i - VLM )} : ( {I}_{t} [ {x}_{min} : {y}_{min} : {x}_{max} : {y}_{max} ] , {P}_{d} ) \to {\{ {A}_{t , i} \}}_{i = 1}^{{n}_{t}}$$

Object orientation is captured from the three-dimensional information of objects in the scene with respect to the vehicle. A three-dimensional object detection model [symbol] predicts pₜ three-dimensional bounding boxes and extracts the yaw θ_{t,i} ∈[−π, π] for each object as

$${ℱ}_{3 Ddet} : ( {I}_{t} ) \to {\{ {θ}_{t , i} \}}_{i = 1}^{{p}_{t}} .$$

Next each 3D bounding box is projected into 2D image space using the camera intrinsic matrix K and the projected boxes are matched with detected objects. The yaw θ_{t,i} is transferred to the corresponding local object.

The outputs 106 of any or all of these types of analysis 104 can thus be translated into a shared format that can be processed by the LLM 110. While structured visual information provides a strong foundation for precise reasoning, a general-purpose video VLM can be used as a peer module to provide an initial, high-level response to the user query based on raw visual input and to expose limitations in generic models that might otherwise lead to incorrect explanations.

To this end, the peer video VLM may be prompted using the original video V to extract its response Dₚₑₑᵣ in block 305. This response is treated as a first-pass hypothesis, which is alter refined by the LLM using structured evidence [symbol] . By comparing Dₚₑₑᵣ with structured scene information, the LLM 110 is encouraged to ground or correct its reasoning based on verifiable cues.

Block 306 translates the various outputs to a shared format, structured data D. D organizes information in a hierarchical manner as shown in FIG. 2, distinguishing between video-level and frame-level details. This structure is intuitive for an LLM because it aligns with how reasoning may occur over temporal sequences. The structured information may be provided in any appropriate format, such as JavaScript Object Notation (JSON).

Block 308 uses the structured data [symbol] to prompt the LLM 110. A prompt P_{LLM} may use a three-block structure to optimize the model's grounded reasoning. A key explanation component provides a precise and explicit interpretation of the scene representation [symbol] , reducing ambiguity in the model's input. LLMs benefit from well-disambiguated inputs when handling symbolic data. A step instructions component decomposes the reasoning task into explicit sub-goals to improve reasoning accuracy and consistency. A peer instruction component informs the model that peer-generated answers may be unreliable and explicitly encourages independent reasoning. These three components of the prompt operationalize input grounding, procedural reasoning, and epistemic caution for robust and generalizable performance in tasks involving multi-step inference from structured dynamic scenes.

Based on the output of the LLM 110, block 310 automatically performs a driving action within the vehicle. For example, the driving action may include accelerating, decelerating, or steering to change the speed and direction of the vehicle.

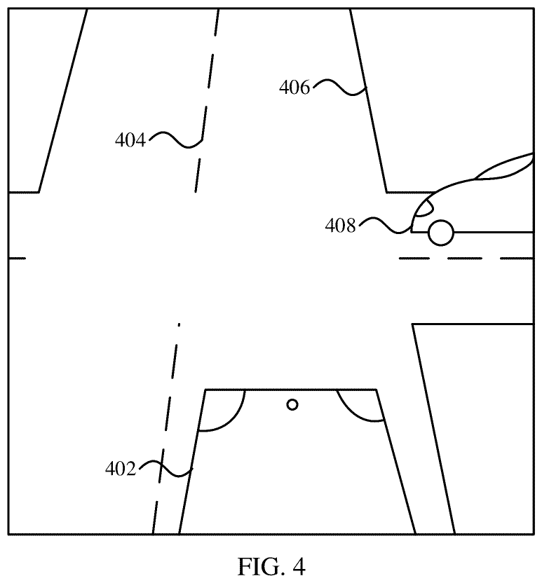

Referring now to FIG. 4, an example scene is shown. The scene may be captured by a camera that is mounted on a vehicle 402, and may show the surroundings of the vehicle 402 from a particular perspective. The illustrated view may be taken using a forward-facing dash-cam on the vehicle 402. It should be understood that multiple such images may be used to show various perspectives, to ensure awareness of the vehicle's entire surroundings. In some cases, a panoramic or 360° camera may be used. In some cases the scene information may include depth information, such as is generated by a light detection and ranging (LiDAR) sensor.

The scene may show a variety of objects. For example, the scene may include environmental features, such as the road boundary 406 and lane markings 404, as well as moving objects, such as other vehicles 408. Other objects, such as pedestrians, animals, road obstructions, road hazards, street lights, and barriers may also be included. A series of images of the scene may be taken together as a video to give a self-driving system within the vehicle 402 the ability to perform path prediction and vehicle control actions.

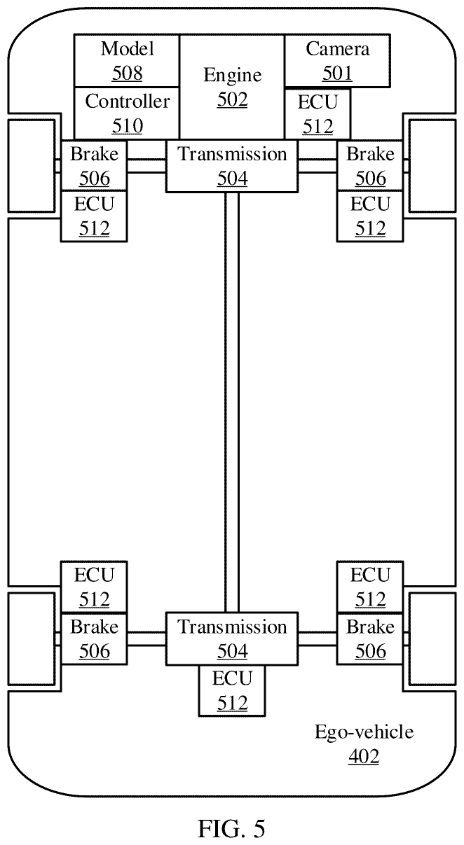

Referring now to FIG. 5, additional detail on a vehicle 402 is shown. A number of different sub-systems of the vehicle 402 are shown, including an engine 502, a transmission 504, and brakes 506. It should be understood that these sub-systems are provided for the sake of illustration, and should not be interpreted as limiting. Additional sub-systems may include user-facing systems, such as climate control, user interface, steering control, and braking control. Additional sub-systems may include systems that the user does not directly interact with, such as tire pressure monitoring, location sensing, collision detection and avoidance, and self-driving.

Each sub-system is controlled by one or more equipment control units (ECUs) 512, which perform measurements of the state of the respective sub-system. For example, ECUs 512 relating to the brakes 506 may control an amount of pressure that is applied by the brakes 506. An ECU 512 associated with the wheels may further control the direction of the wheels. The information that is gathered by the ECUs 512 is supplied to the controller 510. A camera 501 or other sensor (e.g., LiDAR or RADAR) can be used to collect information about the surrounding road scene, and such information may also be supplied to the controller 510.

Communications between ECUs 512 and the sub-systems of the vehicle 402 may be conveyed by any appropriate wired or wireless communications medium and protocol. For example, a car area network (CAN) may be used for communication. The time series information may be communicated from the ECUs 512 to the controller 510, and instructions from the controller 510 may be communicated to the respective sub-systems of the vehicle 402.

Information from the camera 501 and other sensors is provided to the model 508, which may select an appropriate action to take. The controller 510 uses the output of the model 508, based on information collected from cameras 501, to perform a driving action responsive to the present state of the scene. Because the model 508 has been trained on diverse simulated inputs, it will determine a safe and efficient path to its destination.

The controller 510 may communicate internally to the sub-systems of the vehicle 502 and the ECUs 512. Based on detected objects in the scene, the controller 510 may communicate instructions to the ECUs 512 to avoid a hazardous condition. For example, the controller 510 may automatically trigger the brakes 506 to slow down the vehicle 502 and may furthermore provide steering information to the wheels to cause the vehicle 502 to move around a hazard.

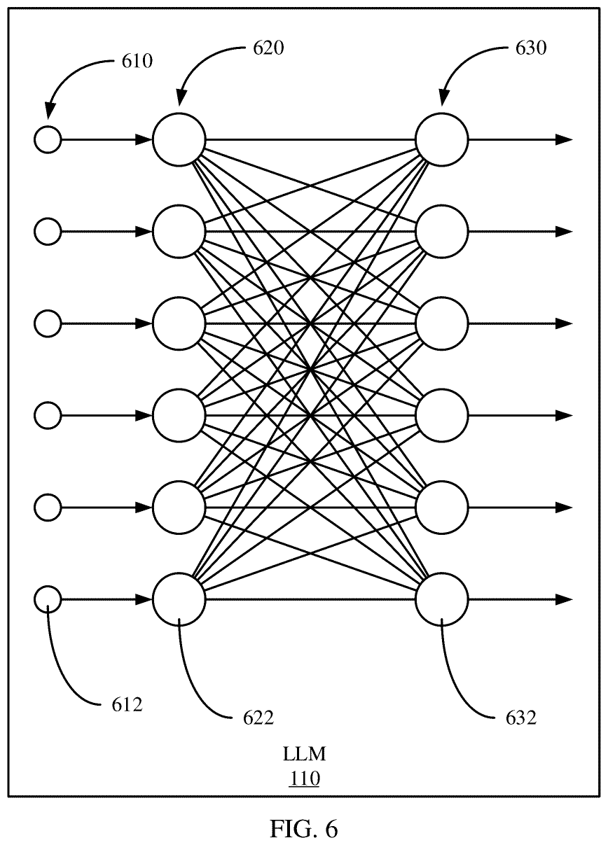

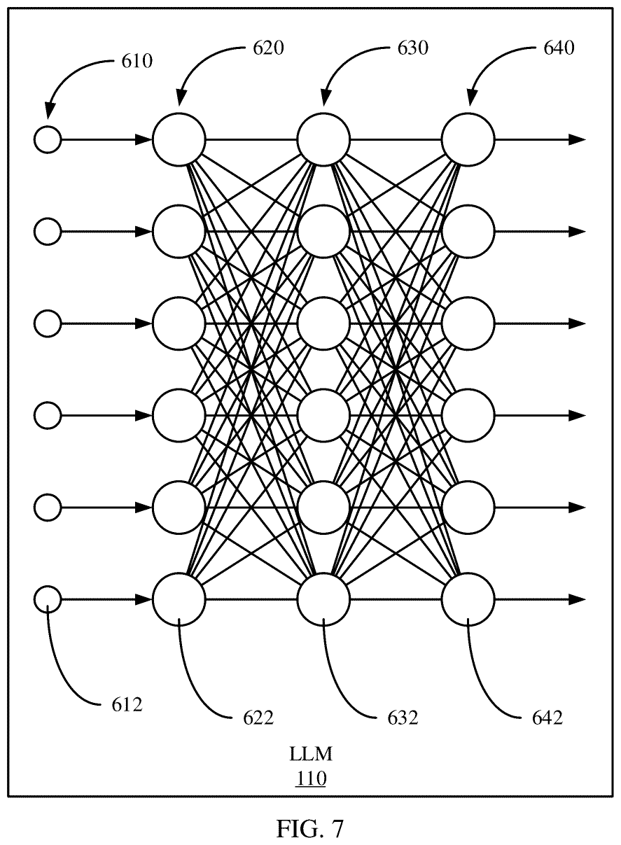

Referring now to FIGS. 6 and 7, exemplary neural network architectures are shown, which may be used to implement parts of the present machine learning models, such as the LLM 110. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 620 of source nodes 622, and a single computation layer 630 having one or more computation nodes 632 that also act as output nodes, where there is a single computation node 632 for each possible category into which the input example could be classified. An input layer 620 can have a number of source nodes 622 equal to the number of data values 612 in the input data 610. The data values 612 in the input data 610 can be represented as a column vector. Each computation node 632 in the computation layer 630 generates a linear combination of weighted values from the input data 610 fed into input nodes 620, and applies a non-linear activation function that is differentiable to the sum. The exemplary simple neural network can perform classification on linearly separable examples (e.g., patterns).

A deep neural network, such as a multilayer perceptron, can have an input layer 620 of source nodes 622, one or more computation layer(s) 630 having one or more computation nodes 632, and an output layer 640, where there is a single output node 642 for each possible category into which the input example could be classified. An input layer 620 can have a number of source nodes 622 equal to the number of data values 612 in the input data 610. The computation nodes 632 in the computation layer(s) 630 can also be referred to as hidden layers, because they are between the source nodes 622 and output node(s) 642 and are not directly observed. Each node 632, 642 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . . Wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 632 in the one or more computation (hidden) layer(s) 630 perform a nonlinear transformation on the input data 612 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for video processing, comprising:
performing a plurality of analyses on an input video from a vehicle to generate respective outputs;
combining the outputs into a structured hierarchical format that divides outputs into frame-level and video-level information;
processing the outputs in the structured hierarchical format using a large language model (LLM) to determine a driving action; and
performing the driving action in the vehicle.

2. The method of claim 1, wherein the plurality of analyses includes scene understanding that generates a natural language description of a scene in the input video.

3. The method of claim 1, wherein the plurality of analyses includes vehicle state estimation that determines the vehicle's motion and turning states.

4. The method of claim 1, wherein the plurality of analyses includes two-dimensional object detection and tracking to locate objects across a plurality of frames in the input video.

5. The method of claim 4, wherein the plurality of analyses includes object lane location to assign lane locations to detected objects in the input video.

6. The method of claim 4, wherein the plurality of analyses includes object distance estimation between detected objects and the vehicle.

7. The method of claim 4, wherein the plurality of analyses includes object attribute determination for detected objects in the input video.

8. The method of claim 4, wherein the plurality of analyses includes three-dimensional detection to determine a pose for detected objects with respect to the vehicle.

9. The method of claim 1, further comprising processing the video input using a visual language model to generate a first-pass hypothesis for a description of the input video, wherein processing the outputs further includes processing the first-pass hypothesis.

10. The method of claim 1, wherein the driving action is selected from the group consisting of acceleration, deceleration, and steering.

11. A video processing system, comprising:
a hardware processor; and
a memory that stores a computer program which, when executed by the hardware processor, causes the hardware processor to:
perform a plurality of analyses on an input video from a vehicle to generate respective outputs;
combine the outputs into a structured hierarchical format that divides outputs into frame-level and video-level information;
process the outputs in the structured hierarchical format using a large language model (LLM) to determine a driving action; and
perform the driving action in the vehicle.

12. The system of claim 11, wherein the plurality of analyses includes scene understanding that generates a natural language description of a scene in the input video.

13. The system of claim 11, wherein the plurality of analyses includes vehicle state estimation that determines the vehicle's motion and turning states.

14. The system of claim 11, wherein the plurality of analyses includes two-dimensional object detection and tracking to locate objects across a plurality of frames in the input video.

15. The system of claim 14, wherein the plurality of analyses includes object lane location to assign lane locations to detected objects in the input video.

16. The system of claim 14, wherein the plurality of analyses includes object distance estimation between detected objects and the vehicle.

17. The system of claim 14, wherein the plurality of analyses includes object attribute determination for detected objects in the input video.

18. The system of claim 14, wherein the plurality of analyses includes three-dimensional detection to determine a pose for detected objects with respect to the vehicle.

19. The system of claim 11, wherein the computer program further causes the hardware processor to process the video input using a visual language model to generate a first-pass hypothesis for a description of the input video, wherein processing of the outputs further includes processing the first-pass hypothesis.

20. The system of claim 11, wherein the driving action is selected from the group consisting of acceleration, deceleration, and steering.
